(19) United States
(12) Patent Application Publication
(10) Pub. No.: US 2022/0076688 A1
(43) Pub. Date: Mar. 10, 2022

(54) METHOD AND APPARATUS FOR OPTIMIZING SOUND QUALITY FOR INSTANT MESSAGING

(71) Applicant: Beijing Dajia Internet Information Technology Co., Ltd., Beijing (CN)

(72) Inventors: Chen ZHANG, Beijing (CN); Liang GUO, Beijing (CN); Pei DONG, Beijing (CN)

(21) Appl. No.: 17/525,204

(22) Filed: Nov. 12, 2021

Related U.S. Application Data
(63) Continuation of application No. PCT/CN2020/079072, filed on Mar. 12, 2020.

(30) Foreign Application Priority Data
May 14, 2019 (CN) 201910400023.4

(51) Int. Cl. G10L 21/0208; G10L 25/81; H04L 12/58

(52) U.S. Cl. CPC G10L 21/0208; G10L 25/81; G10L 2021/02082; H04L 51/04; H04L 51/10

(57) ABSTRACT

Disclosed are an instant messaging sound quality optimization method, an apparatus and a device. The method includes: obtaining first human voice data, the first human voice data being voice data of a user of a first client terminal; using a loudspeaker to play the first human voice data, local background music of a second client terminal to obtain first audio data; using a microphone to collect the first audio data and second human voice data to obtain second audio data, the second human voice data being voice data of a user of a second client terminal; filtering the first human voice data in the second audio data to obtain filtered audio data; when the background music played by the first client terminal is the second client terminal, sending the filtered audio data to the first client terminal to enable the first client terminal to play the filtered audio data.

### CROSS-REFERENCE TO RELATED APPLICATIONS

The disclosure is a continuation of International Application No. PCT/CN2020/079072, filed on Mar. 12, 2020, which claims the priority to the Chinese Patent Application No. 201910400023.4, filed with the China National Intellectual Property Administration on May 14, 2019, the entire contents of which are incorporated herein by reference.

### FIELD

The disclosure relates to the technical field of instant messaging, in particular to an instant messaging sound quality optimization method and apparatus, and a device.

### BACKGROUND

An instant messaging application can support real-time voice communication of two or more messaging parties. In the real-time voice communication, when a user at one end has a high requirement for a play effect, or an instant messaging device used by the user cannot apply earphones, the user at the end, namely, a near-end user, may use a speaker to play a voice of a user at the other end, namely, a remote-end user. At the moment, the voice of the remote-end user played by the speaker may escape into a microphone when the microphone of the near-end user collects a voice of the near-end user, namely, both the voice of the remote-end user and the voice of the near-end user may be collected by the microphone of the near-end user, which will cause a situation that the voice of the near-end user received by the remote-end user contains the voice of the remote-end user collected by the microphone of the near-end user, and an echo of the remote-end user appears in the voice of the near-end user. Accordingly, echo cancellation may be performed on audio data collected by the microphone of the near-end user in the related art, namely, an echo in the audio data collected by the microphone of the near-end user is filtered, and then the voice of the near-end user is obtained and serves as target audio data to be sent to the remote-end user.

### SUMMARY

In order to solve the problem in the related art, the disclosure provides an instant messaging sound quality optimization method and apparatus, and a device.

According to a first aspect of an embodiment of the disclosure, an instant messaging sound quality optimization method is provided, applied to a second client and includes:

obtaining a first human voice data, wherein the first human voice data are voice data of a user of a first client; obtain a first audio data by playing the first human voice data and a local background music of the second client through one or more speakers; obtaining a second audio data by collecting the first audio data and second human voice data through a microphone, wherein the second human voice data is voice data of a user of the second client; filtering the first human voice data in the second audio data to obtain a filtered audio data; and sending the filtered audio data to the first client in response to a background music played by the first client coming from the second client to make the first client play the filtered audio data.

According to a second aspect of an embodiment of the disclosure, another method for optimizing instant messaging sound quality is provided, applied to a first client and includes: sending a first human voice data to a second client to make the second client play the first human voice data and a local background music of the second client through one or more speakers to obtain a first audio data; or sending third audio data to the second client to make the second client filter out a background music in the third audio data to obtain a first human voice data, and play the first human voice data and the local background music of the second client through the one or more speakers to obtain the first audio data, wherein the first human voice data is voice data of a user of the first client, and the third audio data are obtained by collecting the first human voice data and a local background music of the first client through one or more microphones of the first client; receiving a second audio data sent by the second client, wherein the second audio data is obtained by collecting the first audio data and second human voice data through one or more microphone of the second client, and the second human voice data is voice data of a user of the second client; filtering the first human voice data in the second audio data to obtain filtered audio data; and playing the filtered audio data in response to a background music played by the first client coming from the second client.

According to a third aspect of an embodiment of the disclosure, an apparatus for optimizing instant messaging sound quality is provided, applied to a second client and includes: a first human voice obtaining module configured to obtain a first human voice data, wherein the first human voice data is voice data of a user of a first client; a first audio obtaining module configured to obtain a first audio data by playing the first human voice data and a local background music of the second client through one or more speaker; a second audio obtaining module configured to obtain second audio data by collecting the first audio data and second human voice data through one or more microphones, wherein the second human voice data is voice data of a user of the second client; a filtering module configured to filter the first human voice data in the second audio data to obtain filtered audio data; and a sending module configured to send the filtered audio data to the first client in response to a background music played by the first client coming from the second client to make the first client play the filtered audio data.

According to a fourth aspect of an embodiment of the disclosure, another apparatus for optimizing instant messaging sound quality is provided, applied to a first client and includes: a sending module configured to send a first human voice data to a second client to make the second client play the first human voice data and a local background music of the second client through one or more speakers to obtain a first audio data; or send a third audio data to the second client to make the second client filter a background music in the third audio data to obtain the first human voice data, and play the first human voice data and the local background music of the second client through the one or more speakers to obtain the first audio data, wherein the first human voice data is voice data of a user of the first client, and the third audio data is obtained by collecting the first human voice data and a local background music of the first client through one or more microphones of the first client; a receiving module configured to receive a second audio data sent by the second client, wherein the second audio data is obtained by collecting the first audio data and second human voice data through one or more microphone of the second client, and the second human voice data is voice data of a user of the second client; a filtering module configured to filter the first human voice data in the second audio data to obtain filtered audio data; and a playing module configured to play the filtered audio data in response to a background music played by the first client coming from the second client.

According to a fifth aspect of an embodiment of the disclosure, an electronic device is provided, applied to a second client and includes: a processor; and a memory, configured to store executable instructions of the processor, wherein the processor is configured to execute followings: obtaining a first human voice data, wherein the first human voice data is voice data of a user of a first client; obtaining a first audio data by playing the first human voice data and a local background music of the second client through one or more speakers; obtaining a second audio data by collecting the first audio data and second human voice data through one or more microphones, wherein the second human voice data is voice data of a user of the second client; filtering the first human voice data in the second audio data to obtain filtered audio data; and sending the filtered audio data to the first client in response to a background music played by the first client coming from the second client to make the first client play the filtered audio data.

According to a sixth aspect of an embodiment of the disclosure, an electronic device is provided, applied to a first client and includes: a processor; and a memory, configured to store executable instructions of the processor, wherein the processor is configured to execute followings: sending a first human voice data to a second client to make the second client play the first human voice data and a local background music of the second client through one or more speakers to obtain a first audio data; or sending a third audio data to the second client to make the second client filter out a background music in the third audio data to obtain the first human voice data, and play the first human voice data and the local background music of the second client through the one or more speakers to obtain the first audio data, wherein the first human voice data is voice data of a user of the first client, and the third audio data is obtained by collecting the first human voice data and a local background music of the first client through one or more microphones of the first client; receiving a second audio data sent by the second client, wherein the second audio data are obtained by collecting the first audio data and second human voice data through one or more microphones of the second client, and the second human voice data is voice data of a user of the second client; filtering the first human voice data in the second audio data to obtain filtered audio data; and playing the filtered audio data in response to a background music played by the first client comes from the second client.

According to a seventh aspect of an embodiment of the disclosure, a non-temporary computer readable storage medium is provided and contained in an electronic device. When instructions in the storage medium are executed by a processor of the electronic device, the electronic device can execute steps of the instant messaging sound quality optimization method in the above first aspect or second aspect.

According to an eighth aspect of an embodiment of the disclosure, a computer program product is provided. When the computer program product runs on an electronic device, the electronic device executes steps of the instant messaging sound quality optimization method in the above first aspect or second aspect.

### BRIEF DESCRIPTION OF THE DRAWINGS

FIG. 1 is a flow chart of an instant messaging sound quality optimization method shown according to an embodiment.

FIG. 2 is a flow chart of an instant messaging sound quality optimization method shown according to another embodiment.

FIG. 3 is a flow chart of an instant messaging sound quality optimization method shown according to yet another embodiment.

FIG. 4 is a block diagram of an instant messaging sound quality optimization apparatus shown according to an embodiment.

FIG. 5 is a block diagram of an instant messaging sound quality optimization apparatus shown according to another embodiment.

FIG. 6 is a block diagram of an electronic device shown according to an embodiment.

FIG. 7 is a block diagram of an electronic device shown according to another embodiment.

FIG. 8 is a block diagram of an electronic device shown according to yet another embodiment.

FIG. 9 is a block diagram of an electronic device shown according to yet another embodiment.

### DETAILED DESCRIPTION OF THE EMBODIMENTS

An executive subject of an instant messaging sound quality optimization method provided by an embodiment of the disclosure may be an electronic device performing sound quality optimization in an instant messaging system. Exemplarily, the electronic device may be any one of at least two clients performing instant messaging. For example, the client may be specifically a computer, an intelligent mobile terminal, a wearable intelligent terminal and the like. Or exemplarily, the electronic device may be a server corresponding to an instant messaging application, namely, a server corresponding to the client. For example, the server may be specifically a desktop computer, a cloud server, a laptop and the like.

In some scenarios where a background music (BGM) also exists besides voices of users, for example, scenarios of microphone-connected karaoke and microphone-connected short play and the like, the BGM exists in a messaging process all the time and is collected into the audio data sent by the near-end user to the remote-end user after being played through the speaker. At this point, in order to obtain the target audio data, when the audio data sent by the near-end user are filtered in the above echo cancellation mode, filtering needs to be performed continuously, which tends to cause excessive filtering, consequently, a non-echo voice, namely a human voice of the near-end user, which does not need to be filtered will be filtered to a certain degree, and a problem of sound quality loss of the human voice of the near-end user lagging and being loud and small occurs.

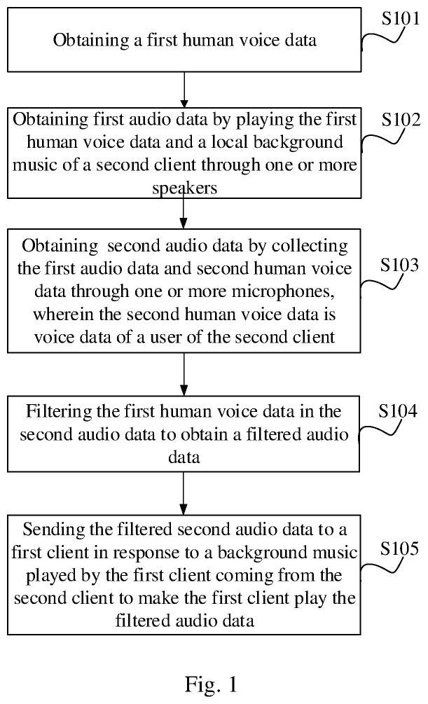

FIG. 1 is a flow chart of an instant messaging sound quality optimization method shown according to an embodiment. As shown in FIG. 1, the instant messaging sound quality optimization method is applied to a second client and may include the following steps.

S101, first human voice data are obtained. The first human voice data are voice data of a user of a first client.

Instant messaging with a background music is performed between the first client and the second client, for example, microphone-connected karaoke, microphone-connected short play and the like. Moreover, there may be various instant messaging systems. Exemplarily, the instant messaging system may be a livestream system, a social communication system, a karaoke system and the like.

For the sake of convenient understanding, in subsequent embodiments, an exemplary description is made by taking an application scenario of the microphone-connected karaoke. In the application scenario of the microphone-connected karaoke, a host client may be regarded as the first client, and a microphone-connected singer client performing microphone-connected karaoke with a host is regarded as the second client. Correspondingly, human voice data of the host are the first human voice data, and human voice data of a microphone-connected singer are the second human voice data.

In the instant messaging system with the background music, when the first client plays the background music in different modes, processing of the first human voice data differs as well, correspondingly, there may be various modes for obtaining the first human voice data by the second client, and a specific description is made below in different embodiments.

In some embodiments, the mode for obtaining the first human voice data by the second client may include:

receiving the first human voice data sent by the first client in response to the first client playing the background music with earphones.

When the first client plays the background music with the earphones, the first human voice data collected by a microphone of the first client are not mixed with a local background music of the first client played by the first client, so that the first client may directly send the first human voice data to the second client, the second client receives the first human voice data sent by the first client, and thus the first human voice data may be obtained.

Further, in some embodiments, there may be various sources of the background music played by the first client. Exemplarily, the background music played by the first client may be sent by the second client to the first client, or locally stored in the first client, or downloaded from a server of the instant messaging system by the first client.

In some embodiments, the mode of obtaining the first human voice data by the second client may include:

receiving the first human voice data sent by the first client in response to the first client playing the background music through one or more speakers. The third audio data are audio data obtained by collecting the first human voice data and a local background music of the first client played by the first client through one or more microphones of the first client. The first human voice data is obtained by filtering out a background music in third audio data by the first client.

If the first client plays the background music through the speakers, the microphones of the first client also collect the local background music of the first client played by the first client when collecting the first human voice data, and at the moment, the third audio data are collected by the microphone of the first client. Therefore, the first client needs to filter out the background music in the third audio data so as to obtain the first human voice data, and the first human voice data are sent to the second client. The second client receives the first human voice data sent by the first client, and thus the first human voice data may be obtained.

In some embodiments, the mode of obtaining the first human voice data by the second client may include:

receiving the third audio data sent by the first client in response to the first client playing the background music through the one or more speakers, and the background music in the third audio data is filtered out so as to obtain the first human voice data.

In these embodiments, an executive subject for filtering out the background music in the third audio data is the second client. The second client filters out the background music in the third audio data after receiving the third audio data sent by the first client so as to obtain the first human voice data.

Any mode for obtaining the first human voice data in the instant messaging system with the background music may be applied to some embodiments of the disclosure, which is not limited herein.

S102, obtaining the first audio data by playing the first human voice data and a local background music of the second client through the one or more speakers.

When the first human voice data and the local background music of the second client are played by the second client through the speakers, the played first human voice data and the local background music of the second client are mixed to be the first audio data. Moreover, playing through the speaker might cause the microphone collects the first audio data while collecting the second human voice data in S103, and consequently the first audio data are mixed into the second human voice data to form second audio data.

There may be various sources of the local background music of the second client. Exemplarily, the background music played by the second client may be locally stored in the second client, or downloaded from the server of the instant messaging system by the first client. Besides, there may be various speakers. Exemplarily, the speaker may be a speaker in the second client, or a speaker box connected with the second client and the like.

S103, obtaining the second audio data by collecting the first audio data and the second human voice data through the one or more microphones. The second human voice data is voice data of a user of the second client.

S104, obtaining a filtered audio data by filtering out the first human voice data in the second audio data.

S105, making the first client play the filtered audio data by sending the filtered audio data to the first client in response to the background music played by the first client coming from the second client.

In some embodiments, the first human voice data in the second audio data may be filtered through an adaptive filter so as to obtain the filtered audio data. For the sake of convenient understanding and reasonable layout, a specific description is made subsequently in some embodiments.

In the above S104, the filtered audio data are obtained by filtering the first human voice data in the second audio data, namely, the filtered audio data are audio data containing the second human voice data collected by the microphone of the second client and the background music collected by the microphone of the second client. In the instant messaging system with the background music, as for the first client, non-echo audio data are the second human voice data, and if the filtered audio data are directly used as the audio data played by the first client, the background music contained in the filtered audio data may become an echo.

In this case, if the background music played by the first client comes from the second client, the background music contained in the filtered audio data may serve as the background music played by the first client, so that the background music in the filtered audio data may be prevented from becoming a noise of the first client, and an effect of echo cancellation is ensured. Therefore, in S105, the filtered audio data may be sent to the first client so as to make the first client play the filtered audio data, and instant messaging of the first client and the second client is realized.

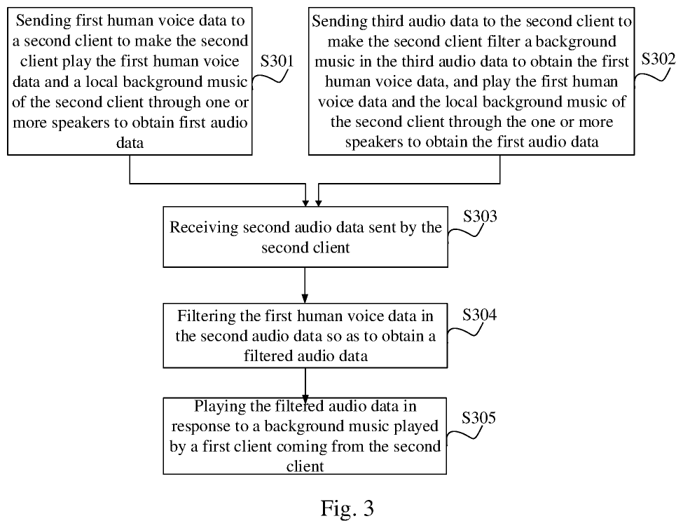

Further, if the background music played by the first client does not come from the second client, for the sake of convenient understanding and reasonable layout, a specific description is made subsequently with reference to FIG. 3.

In some embodiments, the host and the microphone-connected singer perform microphone-connected karaoke of a song S1, and a music accompaniment BGM1 of the song is a background music played by clients of two messaging parties. The microphone-connected singer client obtains the human voice data of the host, and then plays the human voice data of the host and the local BGM1 of the microphone-connected singer client through the speaker, so as to obtain first audio data formed by mixing the human voice data of the host and the local BGM1 of the microphone-connected singer client. The microphone-connected singer client collects the human voice data of the microphone-connected singer generated during singing of the microphone-connected singer and the first audio data through a microphone, so as to obtain second audio data formed by mixing the human voice data of the microphone-connected singer and the first audio data. The human voice data of the host in the second audio data are filtered out so as to obtain filtered audio data. The filtered audio data do not contain the human voice data of the host but only contains the human voice data of the microphone-connected singer and the BGM1. When the BGM1 played by the host client comes from the microphone-connected singer client, the filtered audio data are sent to the host client so as to make the host client play the filtered audio data. At the moment, the audio data played by the host client are the human voice data of the microphone-connected singer and the BGM1 without the echo, so that the effect of echo cancellation is realized. Moreover, a duration of the human voice data of the host is relatively shorter than that of the BGM1 in a microphone-connected karaoke process. Compared with traditional continuous echo filtering of the second audio data, by means of filtering the human voice data of the host in the second audio data, excessive filtering of the second audio data may be reduced, thus excessive filtering of the human voice data of the microphone-connected singer in the second audio data is reduced, the problems of a human voice of the microphone-connected singer lagging, being loud and small and the like are reduced, and sound quality loss of a non-echo human voice of the microphone-connected singer is reduced.

In some embodiments of the disclosure, in the instant messaging system with the background music, as the duration of the first human voice data is shorter than that of the background music, compared with traditional continuous echo filtering of the second audio data, by means of filtering the first human voice data in the second audio data, excessive filtering of the second audio data may be reduced, thus excessive filtering of the second human voice data in the second audio data is reduced, the problems of a human voice of the microphone-connected singer lagging, being loud and small and the like are reduced, and sound quality loss of a non-echo second human voice is reduced. Moreover, in the case that the background music played by the first client comes from the second client, the background music in the filtered audio data may serve as the background music played by the first client. Therefore, in the case that the background music played by the first client comes from the second client, the filtered audio data are sent to the first client to be played, the background music in the filtered audio data may be prevented from becoming the noise of the first client, and the effect of echo cancellation is ensured. Both echo cancellation and the reduction of non-echo human voice loss may be taken into account in the instant messaging system with the background music by means of the present solution.

In some embodiments, the above S104 of obtaining the filtered audio day by filtering out the first human voice data in the second audio data may include:

Obtaining simulated human voice by inputting the second audio data and the obtained first human voice data into the adaptive filter respectively so as to make the adaptive filter simulate the first human voice data in the second audio data based on the first human voice data, and cancel the first human voice data in the second audio data with the simulated human voice data, and determining the filtered audio data based on the second audio data of which the cancellation is completed.

In some embodiments, there may be various adaptive filters. Algorithms adopted by the different adaptive filters and configured to determine whether actual outputs of the adaptive filters reach a preset expected output, namely whether there is a convergence, differ. For example, a least mean square (LMS) adaptive filter adopt a least mean square algorithm to determine whether there is the convergence of an output, and a recursive least squares (RLS) adaptive filter adopts recursive least squares to determine whether there is the convergence. Any adaptive filter may be applied to some embodiments of the disclosure, which is not limited herein.

The second audio data and the obtained first human voice data are input into the adaptive filter respectively, the adaptive filter may use the first human voice data as a reference signal to simulate the first human voice data contained in the second audio data, the second audio data and the simulated human voice data are subtracted, and thus the first human voice data contained in the second audio data is cancelled. Certainly, in order to guarantee that a filtered output reaches an expected output, during filtering, the adaptive filter may judge whether there is a convergence of the filtered audio data, if yes, it is determined that cancellation of the first human voice data in the second audio data is completed, and otherwise, the filtered audio data may be used as a feedback signal, self parameters of the adaptive filter are adjusted based on the feedback signal, and cancellation of the first human voice data is continued after adjustment is completed, which goes circularly continuously till there is the convergence of the filtered audio data.

Further, a residual echo filter may be added behind the adaptive filter so as to improve the effect of echo cancellation. In some embodiments, the residual echo filter may be an NLP filter (similar to the adaptive filter but its difference from the adaptive filter lies in that a to-be-filtered signal is divided into a plurality of sub-bands and filtering is performed for each sub-band).

In above embodiments, compared with filtering both the background music and the first human voice data, the first human voice data in the second audio data are filtered, so that a data volume needing to be processed in a filtering process may be reduced, relatively, time consumption of filtering may be shortened, and sound quality optimization efficiency is improved.

Further, in some embodiments, there may be the plurality of first clients, and in this case, sound quality optimization of instant messaging is similar to that of the above embodiments. The difference lies in that in the case that there are the plurality of first clients, there are the plurality of first human voice data played by the second client through the speaker, and the second audio data collected by the microphone of the second client contains the plurality of first human voice data. In this case, the plurality of first human voice data need to be obtained and are mixed into a reference signal. The second audio data and the reference signal are input into the adaptive filter respectively so as to make the adaptive filter simulate the plurality of first human voice data as echo data in the second audio data based on the reference signal to obtain simulated echo data, and the echo data in the second audio data is cancelled by using the simulated echo data, and the second audio data with cancellation completed is the filtered audio data.

In some embodiments, after collecting the first audio data and the second human voice data through the microphone so as to obtain the second audio data, and before inputting the second audio data and the obtained first human voice data into the adaptive filter respectively, the instant messaging sound quality optimization method provided by some embodiments of the disclosure may further include:

obtaining a first time delay between the first human voice data and the second audio data by comparing the obtained first human voice data and the second audio data.

Correspondingly, said obtaining the simulated human voice data by inputting the second audio data and the obtained first human voice data into the adaptive filter respectively so as to make the adaptive filter simulate the first human voice data in the second audio data based on the input first human voice data includes:

obtaining aligned human voice data by inputting the second audio data, the obtained first human voice data and the first time delay into the adaptive filter respectively so as to make the adaptive filter align the first human voice data and the second audio data based on the first time delay, obtaining the simulated human voice data by simulating the first human voice data in the second audio data based on the aligned human voice data, and canceling the first human voice data in the second audio data with the simulated human voice data.

In some embodiments, the first human voice data obtained by the second client are pure human voice data of a user of the first client, and the second audio data is collected by the microphone of the second client after being played through the speaker of the second client. Therefore, time delay caused by playing and collection exists between the second audio data and the first human voice data obtained by the second client, and consequently, the first human voice data and the second audio data input into the adaptive filter do not correspond to each other completely. For example, the first human voice data starts to be generated at the 30^{th} millisecond after the second audio data starts to be generated. Therefore, if the first human voice data in the second audio data are directly simulated, a problem of inaccurate simulation caused by the first time delay will occur, and a problem of a poor filtering effect of the first human voice data in the second audio data is possibly caused.

For this, in the above embodiments, the first time delay between the first human voice data and the second audio data can be obtained by performing correlation comparison on the first human voice data and the second audio data. Then, the first time delay is input into the adaptive filter when filtering the first human voice data in the second audio data, so as to make the adaptive filter align the first human voice data and the second audio data based on the first time delay, and obtain the aligned human voice data. The first human voice data in the second audio data are filtered out based on the aligned human voice data. Compared with a mode of no alignment based on the first time delay, no time delay exists between the aligned human voice data and second audio data. The first audio data in the second audio data are simulated based on the aligned human voice data, the obtained simulated audio data are more accurate relatively, and thus a filtering effect on the first human voice data in the second audio data may be improved.

Exemplarily, the correlation comparison may be: obtaining a frequency band curve of the first human voice data and a frequency band curve of the second audio data by performing frequency-domain transformation on the obtained first human voice data and the second audio data respectively; and drawing two frequency band curves in the same frequency band coordinate system, and a time when the two frequency band curves intersect for the first time is determined to be the first time delay. The frequency band coordinate system is a two-dimensional coordinate system with a frequency band as a longitudinal axis and the time as a horizontal axis.

Exemplarily, said obtaining aligned human voice data by aligning the first human voice data and the second audio data based on the first time delay may include: in response to the first human voice data generated earlier than the second audio data, the frequency band curve of the first human voice data may be moved backwards on the time axis by a length corresponding to the first time delay; or in response to the first human voice data generated later than the second audio data, the frequency band curve of the first human voice data may be moved forwards on the time axis by the length corresponding to the first time delay; and determining the aligned human voice data based on a moved frequency band curve of the first human voice data. Certainly, time-domain transformation may also be performed on the moved frequency band curve of the first human voice data, and the aligned human voice data can be determined based on data subjected to the time-domain transformation.

Further, in some embodiments, there may be the plurality of first clients. In this case, sound quality optimization of instant messaging is similar to that of the above embodiments. Their difference lies in that when there are the plurality of first clients, there are the plurality of first human voice data played by the second client through the speaker, and thus the second audio data collected by the microphone of the second client contain the plurality of first human voice data. At this point, the plurality of first human voice data need to be obtained and are mixed into the reference signal. Correlation comparison is performed on the reference signal and the second audio data so as to obtain a third time delay between the reference signal and the second audio data. The second audio data, the reference signal and the third time delay are input into the adaptive filter respectively so as to make the adaptive filter align the reference signal and the second audio data based on the third time delay to obtain the aligned reference signal, simulate the plurality of first human voice data as the echo data in the second audio data based on the aligned reference signal to obtain the simulated echo data, and cancel the echo data in the second audio data through the simulated echo data, and the second audio data of which the cancelation is completed are determined to be the filtered audio data.

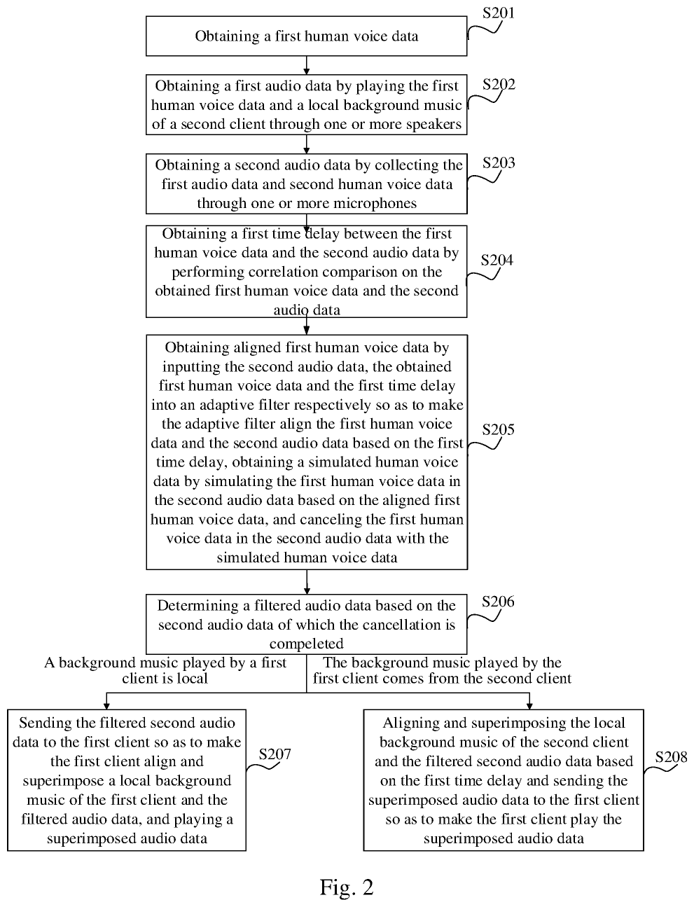

FIG. 2 is a flow chart of an instant messaging sound quality optimization method shown according to some embodiments. As shown in FIG. 2, the method is applied to a second client and may include the following steps.

S201, first human voice data are obtained. The first human voice data are voice data of a user of a first client.

S202, the first human voice data and a local background music of a second client are played through a speaker so as to obtain first audio data.

S203, the first audio data and second human voice data are collected through a microphone so as to obtain second audio data. The second human voice data are voice data of a user of the second client.

S201 to step S203 are the same as S101 to S103 and will not be repeated herein.

S204, a first time delay between the first human voice data and the second audio data is obtained by performing correlation comparison on the obtained first human voice data and the second audio data.

S205, aligned human voice data is obtained by inputting the second audio data, the obtained first human voice data and the first time delay into an adaptive filter respectively so as to make the adaptive filter align the first human voice data and the second audio data based on the first time delay, simulated human voice data is obtained by simulating the first human voice data in the second audio data based on aligned human voice data, and the first human voice data in the second audio data is cancelled based on the simulated human voice data.

S206, determining filtered audio data based on the second audio data with cancellation completed. In response to a background music played by the first client being local, S207 is executed; and in response to the background music played by the first client coming from the second client, S208 is executed.

S205 to S206 are similar to said obtaining the first time delay and the aligned human voice data, and filtering out the first human voice data in the second audio data in the embodiment of obtaining the aligned human voice data based on the first time delay and then filtering in FIG. 1. Their difference lies in that step S206 executes different processing on the filtered audio data based on different sources of the background music played by the first client. The same part is not repeated herein.

S207, the filtered audio data are sent to the first client so as to make the first client align and superimpose a local background music of the first client and the filtered audio data and play superimposed audio data.

In response to the background music played by the first client being local, the time delay caused by transmission of the filtered audio data exists between the background music played by the first client and the filtered audio data received by the first client. If the first client directly plays the received filtered audio data, the background music in the filtered audio data and the local background music of the first client are misaligned, and a playing effect is affected occurs.

In this case, the first client may perform time delay computing and alignment processing on the filtered audio data and the local background music of the first client. No time delay exists between an aligned local background music of the first client obtained through time delay and alignment processing and the filtered audio data. Therefore, in superimposed audio data played by the first client, the local background music of the first client and a background music in the filtered audio data are superimposed with no-time delay. The background music from two sources is prevented from being disaligned, and meanwhile, the background music is enhanced.

In S207, said aligning and superimposing the local background music of the first client and the filtered audio data by the first client may include: the first client obtains a second time delay between the local background music of the first client and the filtered audio data by performing the correlation comparison on the local background music of the first client and the filtered audio data, then obtains an aligned local background music of the first client by aligning the local background music of the first client and the filtered audio data based on the second time delay, and obtains the superimposed audio data by superimposing the aligned local background music of the first client and the filtered audio data. Obtaining of the second time delay and the aligned local background music of the first client is similar to that of the first time delay and the aligned human voice data in the embodiment of the disclosure, and their difference lies in that the second time delay in S207 is between the local background music of the first client and the filtered audio data, and the aligned local background music of the first client is obtained by adjusting the local background music of the first client.

In some embodiments, frequency-domain transformation is performed on the local background music of the first client and the filtered audio data respectively to obtain a frequency band curve of the local background music of the first client and a frequency band curve of the filtered audio data; and the two frequency band curves are drawn in the same frequency band coordinate system, and a time when the two frequency band curves intersect for the first time is determined to be the second time delay. When the local background music of the first client is generated earlier than the filtered audio data, a to-be-played local background music of the first client may be moved backwards by a duration of the second time delay based on a playing time axis of a local music of the first client to obtain the aligned local background music of the first client. Alternatively, the frequency band curve of the local background music of the first client is moved backwards on the time axis by a length corresponding to the second time delay, and the moved frequency band curve of the local background music of the first client is used as the aligned local background music of the first client. Or when the local background music of the first client is generated later than the second audio data, data of the to-be-played local background music of the first client are fast-forwarded by the duration of the second time delay based on the playing time axis of the local music of the first client to obtain the aligned local background music of the first client. Or the frequency band curve of the local background music of the first client may be moved forwards on the time axis by a length corresponding to the first time delay; and the moved frequency band curve of the local background music of the first client is used as the aligned local background music of the first client. Certainly, if the filtered audio data are already frequency-domain data, the filtered audio data may be directly used without the frequency-domain transformation.

S208, the local background music of the second client and the filtered audio data are aligned and superimposed based on the first time delay, and the superimposed audio data are sent to the first client so as to make the first client play the superimposed audio data.

In response to the background music played by the first client coming from the second client, the local background music of the second client may be a background music locally stored in the second client, or downloaded from a server. Moreover, the filtered audio data are obtained by filtering the second audio data collected through the microphone by the second client. Therefore, the time delay, namely the first time delay, caused by collection of the second audio data through the second client exists between the local background music of the second client and the filtered audio data. In this case, the second client may perform alignment processing on the filtered audio data and the local background music of the second client based on the first time delay. No time delay exists between the aligned local background music of the second client obtained through the alignment processing and the filtered audio data. Therefore, in the overlaid audio data played by the first client, the background music is the no-time-delay overlay between the local background music of the second client and the background music in the filtered audio data, the background music from the two sources is prevented from being disordered, and meanwhile, the background music is enhanced.

In S208, the aligning and superimposing the local background music of the second client and the filtered audio data based on the first time delay may include: obtaining an aligned local background music of the second client by aligning the local background music of the second client and the filtered audio data based on the first time delay, and obtaining the overlaid audio data by superimposing the aligned local background music of the second client and the filtered audio data. The first time delay is the time delay obtained in the above embodiment of filtering the first human voice data in the second audio data, which may refer to the description of the above optional embodiment in detail. Obtaining of the aligned local background music of the second client is similar to that of the aligned local background music of the first client in S207, and their difference lies in that the aligned local background music of the second client in S208 is obtained by adjusting the local background music of the second client. The same part is not repeated herein and may refer to the description in above S207 in detail.

Further, in the case that the background music played by the first client comes from the second client, the background music played by the first client may be the background music in the filtered audio data collected by the second client. At the moment, same as S105, the filtered audio data may be sent to the first client so as to make the first client play the filtered audio data.

In some embodiments, in the case that the background music played by the first client comes from the second client, if the background music played by the first client needs to be enhanced, S208 may be executed; or if it is needed to reduce a data volume of transmission and improve the instant messaging efficiency, said sending the filtered audio data to the first client so as to make the first client play the filtered audio data may be executed.

FIG. 3 is a flow chart of an instant messaging sound quality optimization method shown according to yet another exemplary embodiment. As shown in FIG. 3, the method is applied to a first client and may include the following steps.

S301, sending first human voice data to a second client so as to make the second client play the first human voice data and a local background music of the second client through one or more speakers to obtain first audio data. The first human voice data is voice data of a user of the first client.

S302, sending third audio data to the second client so as to make the second client filter a background music in the third audio data to obtain the first human voice data, and to make the second client play the first human voice data and the local background music of the second client through the one or more speakers to obtain the first audio data. The third audio data is audio data obtained by collecting the first human voice data and a local background music of the first client through one or more microphones of the first client.

The above S301 and S302 are parallel steps and are respectively applied to playing the background music by the first client in different modes and different processing modes of data collected by the first client. In some embodiments, in the case that the first client plays the background music with earphones, the local background music of the first client played by the first client will not be mixed into the first human voice data collected by the microphone of the first client, so that S301 may be executed. Alternatively, in the case that the first client plays the background music with a speaker, the local background music of the first client played by the first client is also collected while the microphone of the first client collects the first human voice data, and at the moment, the third audio data are collected through the microphone of the first client. Therefore, the first client may filter the background music in the third audio data so as to obtain the first human voice data, and S301 is executed. Or in the case that the third audio data are collected through the microphone of the first client, S302 may be executed, and the background music in the third audio data is filtered by the second client so as to obtain the first human voice data.

S303, receiving second audio data sent by the second client. The second audio data is obtained by collecting the first audio data and second human voice data through one or more microphones of the second client. The second human voice data is voice data of a user of the second client.

In S303, the second audio data are the same as the second audio data in the related embodiment in FIG. 1 and are not repeated herein.

S304, obtaining the filtered audio data by filtering first human voice data in the second audio data.

Step S305, playing the filtered audio data in response to the background music played by the first client coming from the second client.

The above S304 to S305 are similar to S104 to S105. Their difference lies in that an executive subject of the above S304 to S305 is the first client, and sending of the filtered audio data is not needed. Certainly, if S302 is executed, in order to guarantee that S304 may be executed subsequently, the first client needs to utilize the third audio data to obtain the first human voice data. The same part is not repeated herein.

In some embodiments of the disclosure, in an instant messaging system with the background music, a duration of the first human voice data is shorter than that of the background music, thus compared with traditional continuous echo filtering of the second audio data, by means of filtering out the first human voice data in the second audio data, excessive filtering of the second audio data may be reduced, thus excessive filtering of the second human voice data in the second audio data is reduced, problems of quality loss of the second human voice lagging, and being loud and small and the like are reduced, and sound quality loss of a non-echo second human voice is reduced. Moreover, in a case that the background music played by the first client comes from the second client, a background music in the filtered audio data may serve as the background music played by the first client. Therefore, in a case that the background music played by the first client comes from the second client, the filtered audio data are sent to the first client to be played, the background music in the filtered audio data may be prevented from becoming a noise of the first client, and an effect of echo cancellation is ensured. As you see, both echo cancellation and reduction of loss of the non-echo human voice may be taken into account in the instant messaging system with the background music by means of the present solution.

In some embodiments, after the above S304 of obtaining the filtered audio data by filtering out the first human voice data in the second audio data, the instant messaging sound quality optimization method provided by some embodiments of the disclosure may further include:

in response to the background music played by the first client being local, obtaining second time delay between the local background music of the first client and the filtered audio data by performing a correlation comparison on the local background music of the first client and the filtered audio data;

obtaining an aligned local background music of the first client by aligning the local background music of the first client and the filtered audio data based on the second time delay and obtaining a superimposed audio data by superimposing the aligned local background music of the first client and the filtered audio data; and

playing the superimposed audio data.

Obtaining of the second time delay, the aligned local background music of the first client and the superimposed audio data is similar to that of S207. Their difference lies in that in the present optional embodiment, the executive subject is the first client.

Further, in the case that the background music played by the first client comes from the second client, if it is needed to reduce a data volume of transmission and improve instant messaging efficiency, S305 may be executed. Alternatively, if the background music played by the first client needs to be enhanced, the following steps may be executed:

obtaining a first time delay between the first human voice data and the second audio data by performing the correlation comparison on the first human voice data and the second audio data;

obtaining an aligned local background music of the second client by aligning the received local background music of the second client and the filtered audio data based on the first time delay, and obtaining a superimposed audio data by superimposing the aligned local background music of the second client and the filtered audio data; and

playing the superimposed audio data.

The above is similar to S208, and their difference lies in that in the present embodiment, the executive subject is the first client. As the background music played by the first client in the present optional embodiment is overlay of the background music in the filtered audio data and the received local background music of the second client, the background music may be enhanced compared with only existing of the background music in the filtered audio data.

Corresponding to the above method embodiments, some embodiments of the disclosure further provide an instant messaging sound quality optimization apparatus.

FIG. 4 is a block diagram of an instant messaging sound quality optimization apparatus shown according to an embodiment. The apparatus is applied to a second client and may include: a first human voice obtaining module 401, a first audio obtaining module 402, a second audio obtaining module 403, a filtering module 404 and a sending module 405.

The first human voice obtaining module 401 is configured to obtain first human voice data. The first human voice data is voice data of a user of a first client;

the first audio obtaining module 402 is configured to obtain first audio data based on the first human voice data and a local background music of the second client played through one or more speakers;

the second audio obtaining module 403 is configured to obtain second audio data by collecting the first audio data and second human voice data through one or more microphone. The second human voice data is voice data of a user of the second client;

the filtering module 404 is configured to obtain a filtered audio data by filtering out the first human voice data in the second audio data; and

the sending module 405 is configured to send the filtered audio data to the first client in response to a background music played by the first client coming from the second client so as to make the first client play the filtered audio data.

In some embodiments of the disclosure, in an instant messaging system with a background music, a duration of the first human voice data is shorter than that of the background music, thus compared with traditional continuous echo filtering of the second audio data, by means of filtering the first human voice data in the second audio data, excessive filtering of the second audio data may be reduced, thus excessive filtering of the second human voice data in the second audio data is reduced, problems of quality loss of the second human voice lagging, and being loud and small and the like are reduced, and sound quality loss of a non-echo second human voice is reduced. Moreover, when the background music played by the first client comes from the second client, a background music in the filtered audio data may serve as the background music played by the first client. Therefore, when the background music played by the first client comes from the second client, the filtered audio data are sent to the first client to be played, the background music in the filtered audio data may be prevented from becoming a noise of the first client, and an effect of echo cancellation is ensured. As you see, both echo cancellation and reduction of loss of the non-echo human voice may be taken into account in the instant messaging system with the background music by means of the present solution.

In some embodiments, the first human voice obtaining module 401 is configured to:

receive the first human voice data sent by the first client in response to the first client playing the background music with one or more earphones; or

receive the first human voice data sent by the first client in response to the first client playing the background music through the one or more speakers. The first human voice data is obtained by filtering out a background music in the third audio data by the first client. The third audio data is obtained by collecting the first human voice data and the local background of the first client played by the first client through one or more microphones of the first client; or

receive the third audio data sent by the first client in response to the first client playing the background music through the one or more speakers, and obtain the first human voice data by filtering out the background music in the third audio data.

In some embodiments, the filtering module 404 is configured to:

obtain simulated human voice data by inputting the second audio data and the obtained first human voice data into an adaptive filter respectively so as to make the adaptive filter simulate the first human voice data in the second audio data based on the first human voice data, and cancel the first human voice data in the second audio data with the simulated human voice data; and

determine the filtered audio data based on the second audio data of which the cancelation is completed.

In some embodiments, the apparatus may further include: a time delay alignment module 406.

The time delay alignment module 406 is configured to obtain a first time delay between the first human voice data and the second audio data by performing a correlation comparison on the obtained first human voice data and the second audio data after collecting the first audio data and the second human voice data by the second audio obtaining module 403 through the one or more microphones to obtain the second audio data and before inputting the second audio data and the obtained first human voice data into the adaptive filter respectively through the filtering module 404.

The filtering module 404 is configured to obtain aligned human voice data by respectively inputting the second audio data, the obtained first human voice data and the first time delay into the adaptive filter so as to make the adaptive filter align the first human voice data and the second audio data based on the first time delay, obtain simulated human voice data by simulating the first human voice data in the second audio data based on the aligned human voice data, and cancel the first human voice data in the second audio data with the simulated human voice data.

In some embodiments, the sending module 405 is configured to:

send the filtered audio data to the first client in response to the background music played by the first client being local and after the filtered audio data output by the adaptive filter are obtained so as to make the first client align and superimpose the local background music of the first client and the filtered audio data and play the superimposed audio data; or

in response to the background music played by the first client coming from the second client, the time delay alignment module is configured to align and superimpose the local background music of the second client and the filtered audio data based on the first time delay, and send the superimposed audio data to the first client so as to make the first client play the superimposed audio data.

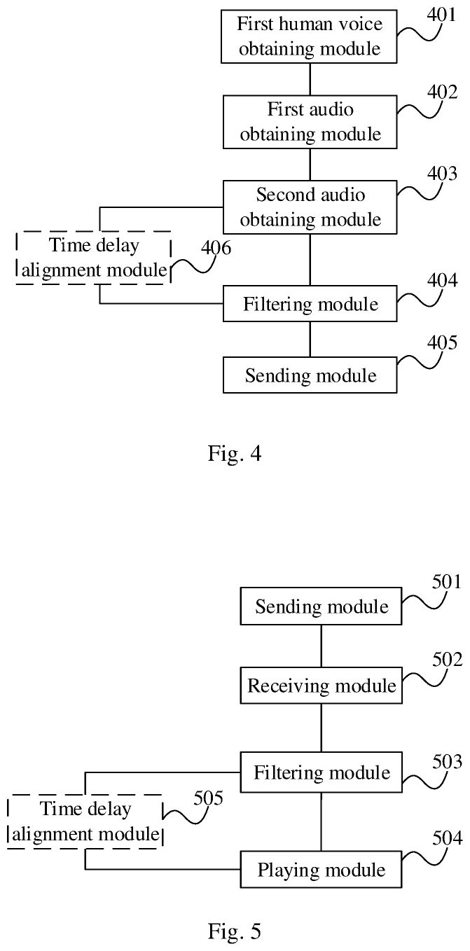

FIG. 5 is a block diagram of an apparatus for optimizing instant messaging sound quality shown according to another embodiment. The apparatus is applied to a first client and may include: a sending module 501, a receiving module 502, a filtering module 503 and a playing module 504.

The sending module 501 is configured to send first human voice data to a second client so as to make the second client play the first human voice data and a local background music of the second client through one or more speakers to obtain first audio data, wherein the first human voice data is voice data of a user of the first client; or send third audio data to the second client so as to make the second client filter a background music in the third audio data to obtain the first human voice data, and play the first human voice data and the local background music of the second client through the one or more speakers to obtain the first audio data, wherein the third audio data is obtained by collecting the first human voice data and a local background music of the first client through one or more microphones of the first client.

The receiving module 502, is configured to receive second audio data sent by the second client. The second audio data are audio data obtained by collecting the first audio data and the second human voice data through a microphone of the second client, and the second human voice data are voice data of a user of the second client.

The filtering module 503 is configured to filter out the first human voice data in the second audio data so as to obtain filtered audio data.

The playing module 504 is configured to play the filtered audio data in response to a background music played by the first client coming from the second client.

In some embodiments of the disclosure, in an instant messaging system with a background music, a duration of the first human voice data is shorter than that of the background music, thus compared with traditional continuous echo filtering of the second audio data, by means of filtering the first human voice data in the second audio data, excessive filtering of the second audio data may be reduced, thus excessive filtering of the second human voice data in the second audio data is reduced, problems of second human voice lagging, being loud and small and the like are reduced, and sound quality loss of a non-echo second human voice is reduced. Moreover, when the background music played by the first client comes from the second client, a background music in the filtered audio data may serve as the background music played by the first client. Therefore, when the background music played by the first client comes from the second client, the filtered audio data are sent to the first client to be played, the background music in the filtered audio data may be prevented from becoming a noise of the first client, and an effect of echo cancellation is ensured. As you see, both echo cancellation and reduction of loss of the non-echo human voice may be taken into account in the instant messaging system with the background music by means of the present solution.

In some embodiments, the apparatus further includes: a time delay alignment module 505.

The time delay alignment module 505 is configured to obtain a second time delay between the local background music of the first client and the filtered audio data by performing a correlation comparison on the local background music of the first client and the filtered audio data in response to the background music played by the first client being local and after the filtering module 503 filters the first human voice data in the second audio data to obtain the filtered audio data; and

obtain an aligned local background music of the first client by aligning the local background music of the first client and the filtered audio data based on the second time delay, and obtain superimposed audio data by superimposing the aligned local background music of the first client and the filtered audio data.

The playing module 504 is configured to play the superimposed audio data.

Corresponding to the above method embodiments, some embodiments of the disclosure further provide an electronic device.

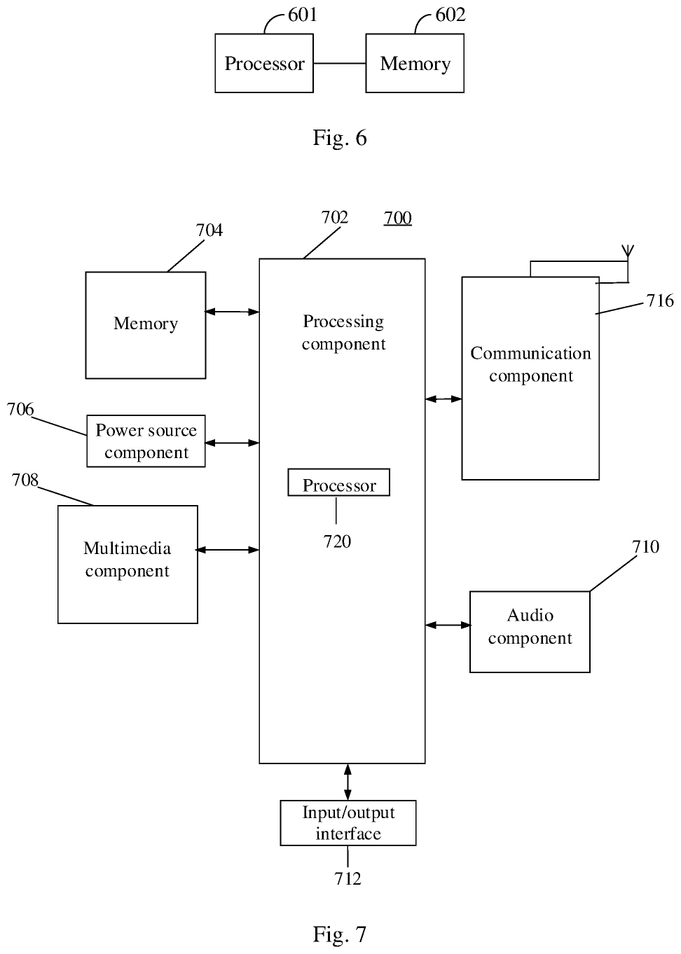

FIG. 6 is an electronic device shown according to an exemplary embodiment. The electronic device may include:

a processor 601; and

a memory 602, configured to store executable instructions of the processor.

The processor 601 is configured to: implement steps of any instant messaging sound quality optimization method applied to a second client and provided by some embodiments of the disclosure when executing the executable instructions stored on the memory 602.

It may be understood that the electronic device is the second client in an instant messaging system. In some embodiments, the electronic device may be a computer, an intelligent mobile terminal, a tablet device, a server and the like.

FIG. 7 is a block diagram of an electronic device 700 shown according to another embodiment. The electronic device 700 may be a mobile phone, a computer, a digital broadcast terminal, a message transceiving device, a game console, a tablet device, a fitness device, a personal digital assistant and the like.

Referring to FIG. 7, the electronic device 700 may include one or more components as follows: a processing component 702, a memory 704, a power source component 706, a multimedia component 708, an audio component 710, an input/output (I/O) interface 712 and a communication component 716.

The processing component 702 generally controls a whole operation of the electronic device 700, such as operations related to display, phone call, data communication, camera operation and recording operation. The processing component 702 may include one or more processors 720 for executing instructions so as to complete all or part of steps of the above method. Besides, the processing component 702 may include one or more modules to facilitate interaction between the processing component 702 and the other components. For example, the processing component 702 may include a multimedia module so as to facilitate interaction between the multimedia component 708 and the processing component 702.

The memory 704 is configured to store various types of data so as to support operations on the device 700. Examples of these data include instructions of any application program or method for operation on the electronic device 700, contact person data, telephone directory data, messages, pictures, videos and the like. The memory 704 may be implemented by any type of volatile or non-volatile storage device or their combination, such as a static random access memory (SRAM), an electrically erasable programmable read only memory (EEPROM), an erasable programmable read-only memory (EPROM), a programmable read-only memory (PROM), a read-only memory (ROM), a magnetic memory, a flash memory, a magnetic disk or a compact disc.

The power source component 706 provides power for the various components of the device 700. The power source component 706 may include a power management system, one or more power sources, and other components related to power generation, management and distribution for the device 700.

The multimedia component 708 includes a screen which provides an output interface between the device 700 and a user. In some embodiments, the screen may include a liquid crystal display (LCD) and a touch panel (TP). If the screen includes the touch panel, the screen may be implemented as a touch screen so as to receive an input signal from the user. The touch panel includes one or more touch sensors so as to sense touching, swiping and gestures on the touch panel. The touch sensor can not only sense a boundary of a touching or swiping action, but also detect duration and pressure related to a touching or swiping operation. In some embodiments, the multimedia component 708 includes a front camera and/or a rear camera. When the device 700 is in an operation mode, such as a photographing mode or a video mode, the front camera and/or the rear camera can receive external multimedia data. Each front camera and each rear camera may be a fixed optical lens system or have a focal length and an optical zoom capability.

The audio component 710 is configured to output and/or input an audio signal. For example, the audio component 710 includes a microphone (MIC). When the device 700 is in the operation mode, such as a call mode, a recording mode and a voice recognition mode, the microphone is configured to receive an external audio signal. The received audio signal may be further stored in the memory 704 or sent through the communication component 716. In some embodiments, the audio component 710 may further include a speaker for outputting the audio signal.

The I/O interface 712 provides an interface between the processing component 702 and a peripheral interface module, and the above peripheral interface module may be a keyboard, a click wheel, buttons and the like. These buttons may include but are not limited to: a home button, a volume button, a start button and a lock button.

The communication component 716 is configured to facilitate wired or wireless communication between the device 700 and the other devices. The device 700 may be accessed to a wireless network based on a communication standard, such as WiFi, a service provider network (such as 2G, 3G, 4G or 5G) or their combination. In an exemplary embodiment, the communication component 716 receives a broadcast signal or related broadcast information from an external broadcast management system through a broadcast channel. In an exemplary embodiment, the communication component 716 may further include a near-field communication (NFC) module so as to facilitate short-range communication. For example, the NFC module may be implemented based on a radio frequency identification (RFID) technology, an infrared data association (IrDA) technology, an ultra wideband (UWB) technology, a Blue tooth (BT) technology and other technologies.

In an exemplary embodiment, the electronic device 700 may be implemented by one or more application specific integrated circuits (ASICs), digital signal processors (DSP), digital signal processing devices (DSPD), programmable logic devices (PLD), field-programmable gate arrays (FPGA), controllers, microcontrollers, microprocessors or other electronic elements for executing the above instant messaging sound quality optimization method applied to a second client.

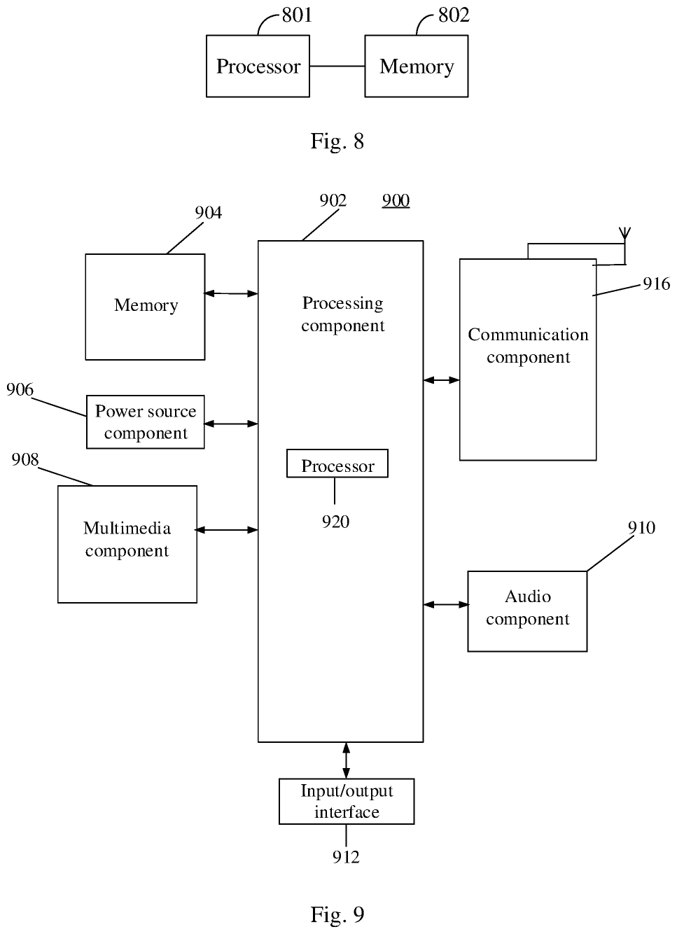

FIG. 8 is an electronic device shown according to yet another exemplary embodiment. The electronic device may include:

a processor 801; and

a memory 802, configured to store executable instructions of the processor.

The processor 801 is configured to: implement steps of any instant messaging sound quality optimization method applied to a first client and provided by some embodiments of the disclosure when executing the executable instructions stored on the memory 802.

It may be understood that the electronic device is the first client in an instant messaging system. In some embodiments, the electronic device may be a computer, an intelligent mobile terminal, a tablet device, a server and the like.

FIG. 9 is a block diagram of an electronic device 900 shown according to yet another exemplary embodiment. The electronic device 900 may be a mobile phone, a computer, a digital broadcast terminal, a message transceiving device, a game console, a tablet device, a fitness device, a personal digital assistant and the like.

Referring to FIG. 9, the electronic device 900 may include one or more components as follows: a processing component 902, a memory 904, a power source component 906, a multimedia component 908, an audio component 910, an input/output (I/O) interface 912 and a communication component 916.

The processing component 902 generally controls a whole operation of the electronic device 900, such as operations related to display, phone call, data communication, camera operation and recording operation. The processing component 902 may include one or more processors 920 for executing instructions so as to complete all or part of steps of the above method. Further, the processing component 902 may include one or more modules to facilitate interaction between the processing component 902 and the other components. For example, the processing component 902 may include a multimedia module so as to facilitate interaction between the multimedia component 908 and the processing component 902.

The memory 904 is configured to store various types of data so as to support operations on the device 900. Examples of these data include instructions of any application program or method for operation on the electronic device 900, contact person data, telephone directory data, messages, pictures, videos and the like. The memory 904 may be implemented by any type of volatile or non-volatile storage device or their combination, such as a static random access memory (SRAM), an electrically erasable programmable read only memory (EEPROM), an erasable programmable read-only memory (EPROM), a programmable read-only memory (PROM), a read-only memory (ROM), a magnetic memory, a flash memory, a magnetic disk or a compact disc.

The power source component 906 provides power for the various components of the device 900. The power source component 906 may include a power management system, one or more power sources, and other components related to power generation, management and distribution for the device 900.

The multimedia component 908 includes a screen which provides an output interface between the device 900 and a user. In some embodiments, the screen may include a liquid crystal display (LCD) and a touch panel (TP). If the screen includes the touch panel, the screen may be implemented as a touch screen so as to receive an input signal from the user. The touch panel includes one or more touch sensors so as to sense touching, swiping and gestures on the touch panel. The touch sensor can not only sense a boundary of a touching or swiping action, but also detect duration and pressure related to a touching or swiping operation. In some embodiments, the multimedia component 908 includes a front camera and/or a rear camera. When the device 900 is in an operation mode, such as a photographing mode or a video mode, the front camera and/or the rear camera can receive external multimedia data. Each front camera and each rear camera may be a fixed optical lens system or have a focal length and an optical zoom capability.

The audio component 910 is configured to output and/or input an audio signal. For example, the audio component 910 includes a microphone (MIC). When the device 900 is in an operation mode, such as a call mode, a recording mode and a voice recognition mode, the microphone is configured to receive an external audio signal. The received audio signal may be further stored in the memory 904 or sent through the communication component 916. In some embodiments, the audio component 910 may further include a speaker for outputting the audio signal.

The I/O interface 912 provides an interface between the processing component 902 and a peripheral interface module, and the above peripheral interface module may be a keyboard, a click wheel, buttons and the like. These buttons may include but are not limited to: a home button, a volume button, a start button and a lock button.

The communication component 916 is configured to facilitate wired or wireless communication between the device 900 and the other devices. The device 900 may be accessed to a wireless network based on a communication standard, such as WiFi, a service provider network (such as 2G, 3G, 4G or 5G) or their combination. In an exemplary embodiment, the communication component 916 receives a broadcast signal or related broadcast information from an external broadcast management system through a broadcast channel. In an exemplary embodiment, the communication component 916 may further include a near field communication (NFC) module so as to facilitate short-range communication. For example, the NFC module may be implemented based on a radio frequency identification (RFID) technology, an infrared data association (IrDA) technology, an ultra wideband (UWB) technology, a Blue tooth (BT) technology and other technologies.

In an embodiment, the electronic device 900 may be implemented by one or more application specific integrated circuits (ASICs), digital signal processors (DSP), digital signal processing devices (DSPD), programmable logic devices (PLD), field-programmable gate arrays (FPGA), controllers, microcontrollers, microprocessors or other electronic elements for executing the above instant messaging sound quality optimization method applied to a first client.

Further, some embodiments of the disclosure further provide a non-temporary computer readable storage medium contained in an electronic device. When instructions in the storage medium are executed by a processor of the electronic device, the electronic device can execute steps of any instant messaging sound quality optimization method applied to a second client in some embodiments of the disclosure.

In an embodiment, a non-temporary computer readable storage medium including the instructions is, for example, a memory 602 including the instructions which may be executed by the processor 601 so as to complete the above method; or a memory 704 including the instructions which may be executed by a processing component 702 of the electronic device 700 so as to complete the above instant messaging sound quality optimization method applied to the second client. For example, the non-temporary computer readable storage medium may be a read-only memory (ROM), a random access memory (RAM), a compact disc read-only memory (CD-ROM), a magnetic tape, a floppy disc, an optical data storage device and the like.

An embodiment of the disclosure further provides another non-temporary computer readable storage medium contained in an electronic device. When instructions in the storage medium are executed by a processor of the electronic device, the electronic device can execute steps of any instant messaging sound quality optimization method applied to a first client in some embodiments of the disclosure.

In an embodiment, a non-temporary computer readable storage medium including the instructions is, for example, a memory 802 including the instructions which may be executed by the processor 801 so as to complete the above instant messaging sound quality optimization method applied to the first client; or a memory 904 including the instructions which may be executed by a processing component 902 of the electronic device 900 so as to complete the above method. For example, the non-temporary computer readable storage medium may be a read-only memory (ROM), a random access memory (RAM), a compact disc read-only memory (CD-ROM), a magnetic tape, a floppy disc, an optical data storage device and the like.

A yet another embodiment provided by the disclosure further provides a computer program product containing instructions. When the computer program product runs on an electronic device, the electronic device executes any instant messaging sound quality optimization method applied to a second client in the above embodiment.

A yet another embodiment provided by the disclosure further provides a computer program product containing instructions. When the computer program product runs on an electronic device, the electronic device executes any instant messaging sound quality optimization method applied to a first client in the above embodiment.

The above embodiments may be implemented totally or partially through software, hardware, a firmware or any combination thereof. When the software is adopted for implementation, some embodiments may be implemented totally or partially in a form of a computer program product. The computer program product includes one or more computer instructions. When the computer program instructions are loaded or executed on a computer, a flow or functions according to some embodiments of the disclosure are generated totally or partially. The computer may be a general-purpose computer, a special-purpose computer, a computer network or other programmable apparatuses. The computer instructions may be stored in a computer readable storage medium or transmitted from one computer readable storage medium to another computer readable storage medium. For example, the computer instructions may be transmitted from one website, a computer, a server or a data center to another website, another computer, another server or another data center in a wired mode, for example, a coaxial cable, an optical fiber and a digital subscriber line (DSL) or in a wireless mode, for example, infrared rays, a radio, microwaves and the like. The computer readable storage medium may be any available medium capable of being accessed by the computer or a data storage device such as a server and a data center integrated by one or more applicable media. The available medium may be a magnetic medium, for example, a floppy disc, a hard disk and a magnetic tape or an optical medium, for example, a digital versatile disc (DVD), or a semiconductor medium, for example, a solid state disk (SSD) and the like.

What is claimed is:

1. A method for optimizing sound quality for instant messaging, applied to a second client and comprising:
obtaining a first human voice data, wherein the first human voice data are voice data of a user of a first client;
obtaining a first audio data by playing the first human voice data and a local background music of the second client through one or more speakers;
obtaining a second audio data by collecting the first audio data and a second human voice data through one or more microphones, wherein the second human voice data is voice data of a user of the second client;
filtering the first human voice data in the second audio data to obtain a filtered audio data; and
sending the filtered audio data to the first client in response to a background music played by the first client coming from the second client to make the first client play the filtered audio data.

2. The method according to claim 1, wherein said obtaining the first human voice data comprises:
receiving the first human voice data sent by the first client in response to the first client playing the background music with earphones; or
receiving the first human voice data sent by the first client in response to the first client playing the background music through one or more speakers, wherein the third audio data are obtained by collecting the first human voice data and a local background music played by the first client through a microphone of the first client, and the first human voice is obtained by filtering out a background music in a third audio data by the first client; or
receiving a third audio data sent by the first client in response to the first client playing the background music through the one or more speakers; and obtaining the first human voice data by filtering out the background music in the third audio data.

3. The method according to claim 1, wherein said obtaining the filtered audio data by filtering the first human voice data in the second audio data comprises:
obtaining simulated human voice data by inputting the second audio data and the obtained first human voice data into an adaptive filter respectively to make the adaptive filter simulate the first human voice data in the second audio data based on the obtained first human voice data;
cancelling the first human voice data in the second audio data with the simulated human voice data; and
determining the filtered audio data based on the second audio data of which the cancellation is completed.

4. The method according to claim 3, further comprising:
obtaining a first time delay between the first human voice data and the second audio data by performing correlation comparison on the obtained first human voice data and the second audio data, wherein
said obtaining the simulated human voice data by inputting the second audio data and the obtained first human voice data into the adaptive filter respectively to make the adaptive filter simulate the first human voice data in the second audio data based on the input first human voice data, comprises:
obtaining an aligned human voice data by inputting the second audio data, the obtained first human voice data and the first time delay into the adaptive filter respectively to make the adaptive filter align the first human voice data and the second audio data based on the first time delay;
obtaining the simulated human voice data by simulating the first human voice data in the second audio data based on the aligned human voice data, and canceling the first human voice data in the second audio data with the simulated human voice data.

5. The method according to claim 4, further comprising:
sending the filtered audio data to the first client in response to the background music played by the first client being local to make the first client align and superimpose a local background music of the first client with the filtered audio data, and play the superimposed audio data; or
aligning and superimposing the local background music of the second client and the filtered audio data based on the first time delay in response to the background music played by the first client coming from the second client, and sending the superimposed audio data to the first client to make the first client play the superimposed audio data.

6. A method for optimizing sound quality for instant messaging, applied to a first client and comprising:
sending a first human voice data to a second client to make the second client play the first human voice data and a local background music of the second client through a speaker to obtain a first audio data; or sending a third audio data to the second client to make the second client filter out a background music in the third audio data to obtain the first human voice data, and to make the second client to play the first human voice data and the local background music of the second client through the speaker to obtain the first audio data, wherein the first human voice data are voice data of a user of the first client, and the third audio data are audio data obtained by collecting the first human voice data and a local background music of the first client through a microphone of the first client;
receiving a second audio data sent by the second client, wherein the second audio data are audio data obtained by collecting the first audio data and a second human voice data through a microphone of the second client, and the second human voice data are voice data of a user of the second client;
filtering out the first human voice data in the second audio data to obtain a filtered audio data; and
playing the filtered audio data in response to a background music played by the first client coming from the second client.

7. The method according to claim 6, further comprising:
obtaining a second time delay between a local background music of the first client and the filtered audio data by performing correlation comparison on the local background music of the first client and the filtered audio data in response to the background music played by the first client being local;
obtaining an aligned local background music of the first client by aligning the local background music of the first client and the filtered audio data based on the second time delay;
superimposing the aligned local background music of the first client with the filtered audio data to obtain an overlaid audio data; and
playing the superimposed audio data.

8. An electronic device, applied to a second client and comprising:
a processor; and
a memory configured to store executable instructions of the processor, wherein
the processor is configured to execute followings:
obtaining a first human voice data, wherein the first human voice data are voice data of a user of a first client;
obtaining a first audio data by playing the first human voice data and a local background music of the second client through one or more speakers;
obtaining a second audio data by collecting the first audio data and a second human voice data through one or more microphones, wherein the second human voice data is voice data of a user of the second client;
filtering the first human voice data in the second audio data to obtain a filtered audio data; and
sending the filtered audio data to the first client in response to a background music played by the first client coming from the second client to make the first client play the filtered audio data.

9. The electronic device according to claim 15, wherein the processor is configured to execute followings:
receiving the first human voice data sent by the first client in response to the first client playing the background music with earphones; or
receiving the first human voice data sent by the first client in response to the first client playing the background music through the one or more speakers, wherein the third audio data are obtained by collecting the first human voice data and a local background music played by the first client through the microphone of the first client, and the first human voice is obtained by filtering out a background music in third audio data by the first client; or
receiving the third audio data sent by the first client in response to the first client playing the background music through the one or more speakers; and obtaining the first human voice data by filtering out the background music in the third audio data.

10. The electronic device according to claim 15, wherein the processor is configured to execute followings:
obtaining simulated human voice data by inputting the second audio data and the obtained first human voice data into an adaptive filter respectively to make the adaptive filter simulate the first human voice data in the second audio data based on the first human voice data, and cancelling the first human voice data in the second audio data with the simulated human voice data; and
determining the filtered audio data based on the second audio data of which the cancellation is completed.

11. The electronic device according to claim 17, wherein the processor is further configured to execute followings:
obtaining a first time delay between the first human voice data and the second audio data by performing a correlation comparison on the obtained first human voice data and the second audio data;
obtaining an aligned human voice data by inputting the second audio data, the obtained first human voice data and the first time delay into the adaptive filter respectively to make the adaptive filter align the first human voice data and the second audio data based on the first time delay;
obtaining simulated human voice data by simulating the first human voice data in the second audio data based on the aligned human voice data, and canceling the first human voice data in the second audio data with the simulated human voice data.

12. The electronic device according to claim 18, wherein the processor is further configured to execute followings:
sending the filtered audio data to the first client in response to the background music played by the first client being local to make the first client align and superimpose a local background music of the first client with the filtered audio data, and play the superimposed audio data; or
aligning and superimposing the local background music of the second client and the filtered audio data based on the first time delay in response to the background music played by the first client coming from the second client, and sending the superimposed audio data to the first client to make the first client play the superimposed audio data.
